(19) United States
(12) Patent Application Publication
(10) Pub. No.: US 2008/0313054 A1
(43) Pub. Date: Dec. 18, 2008

(54) DELIVERY STORAGE APPARATUS AND SYSTEM AND A METHOD FOR THE SAME

(76) Inventor: Kyu Nam LEE, Rancho Palos Verdes, CA (US)

Correspondence Address: SUGHRUE MION, PLLC, 2100 PENNSYLVANIA AVENUE, N.W., SUITE 800, WASHINGTON, DC, 20037, US

(21) Appl. No.: 12/201,729

(22) Filed: Aug. 29, 2008

Related U.S. Application Data
(62) Division of application No. 11/340,689, filed on Jan. 27, 2006.
(60) Provisional application No. 60/647,289, filed on Jan. 27, 2005.

(51) Int. Cl. G06Q 30/00

(52) U.S. Cl. 705/26

(57) ABSTRACT

An apparatus, system and method for delivery storage. The delivery storage apparatus includes an outer opening to allow an individual delivering the goods to place the articles of food directly into the delivery storage apparatus disposed at a side of a house without the presence of the owner. The delivery storage apparatus also includes an inner opening to allow the owner to retrieve the articles of food from the delivery storage apparatus.

### CROSS-REFERENCE TO RELATED PATENT APPLICATION

This application claims the benefit of U.S. Provisional Patent Application No. 60/647,289, filed on Jan. 27, 2005, at the U.S. Patent and Trademark Office, the disclosure of which is incorporated herein in its entirety by reference.

### BACKGROUND OF THE INVENTION

1. Field of the Invention

Apparatuses, systems and methods consistent with the present invention relate to delivery storage. More specifically, the invention relates to the storage of delivered goods and a delivery storage apparatus with dual openings; one placed in the front and the other placed at the rear.

2. Description of the Related Art

In today's fast paced society, delivery of groceries, food, and foodstuffs are becoming ever so popular. Since the items are being delivered, a person has to be present at the delivery address to receive the groceries, food, or foodstuffs which may be perishable.

### SUMMARY OF THE INVENTION

An exemplary embodiment of the present invention is a storage apparatus including a first door and a second door; and a storage compartment accessible through the first door and the second door, wherein the first door is disposed at one side of a means for dividing and the second door is disposed at another side of the means for dividing.

An another exemplary embodiment of the invention is a system for storing delivered goods, the system including a building including a wall; and a storage apparatus disposed at the wall, the storage including a first door and a second door; and a storage compartment accessible through the first door and the second door, wherein the first door is disposed at an exterior of the building and the second door is disposed in an interior of the building.

Yet another embodiment of the invention is a method for a customer to order an item through the Internet, the method including: receiving an order for an item at a website and a delivery address specified by the customer; receiving a customer-defined password at the website; delivering the item to the delivery address; transmitting the customer-defined password to open a storage apparatus at the delivery address; and placing the item in the storage.

### BRIEF DESCRIPTION OF THE DRAWINGS

The above and other aspects of the present invention will become more apparent by describing in detail exemplary embodiments thereof with reference to the attached drawings in which:

FIG. 1 is a cross sectional overview of a building with the delivery storage apparatus installed in place;

FIG. 2 is a front perspective view of the delivery storage apparatus with the front and the rear openings opened;

FIG. 3 is a front perspective view of the delivery storage apparatus with the front and the rear doors closed;

FIG. 4 is a front perspective view of the delivery storage apparatus with the front doors opened and the rear doors closed;

FIG. 5 is a rear perspective view of the delivery storage apparatus with the rear and the front doors closed;

FIG. 6 is a rear perspective view of the delivery storage apparatus with the rear doors opened and the front doors closed;

FIG. 7 is a perspective view of a security control box placed at the rear of the delivery storage apparatus; and

FIG. 8 is a perspective view of a remote control.

### DETAILED DESCRIPTION OF EXEMPLARY EMBODIMENTS THE INVENTION

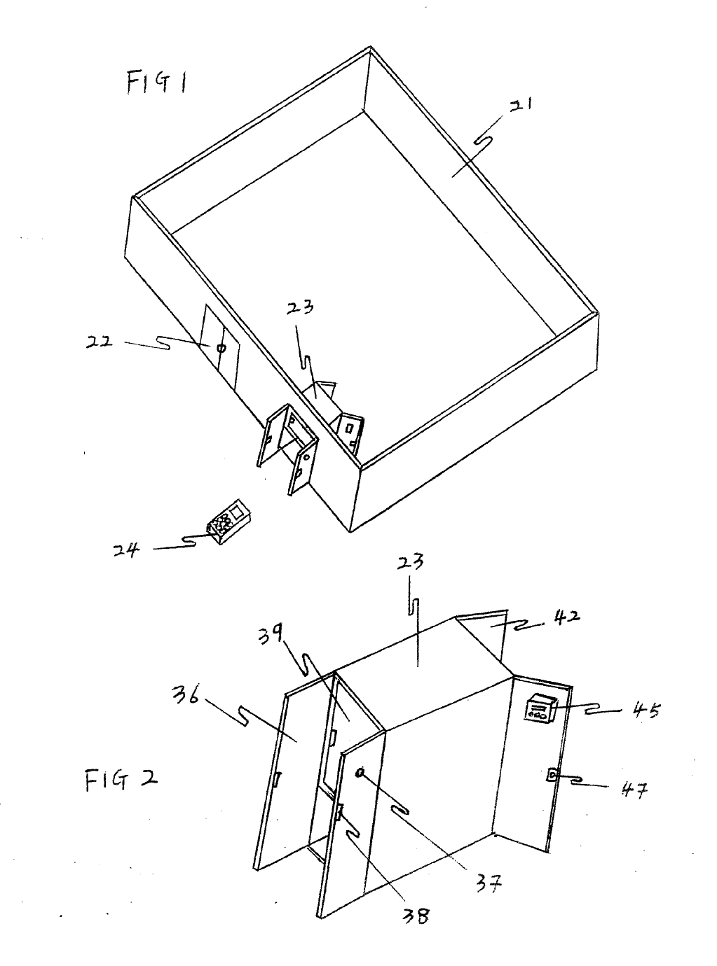

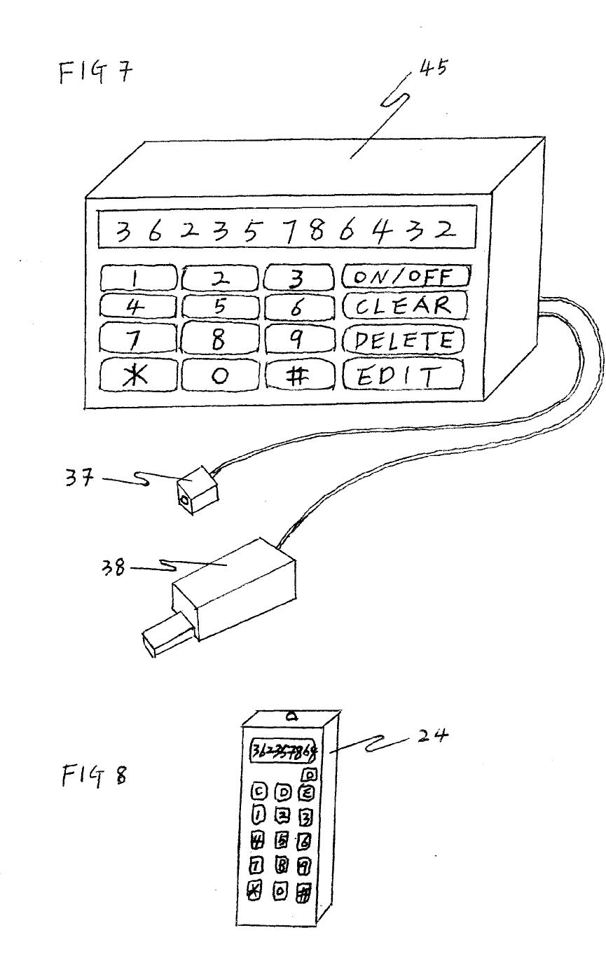

An exemplary embodiment will now be described with reference to FIGS. 1 through 8. FIGS. 1 and 8 show an exemplary embodiment of the delivery storage apparatus 23 and a remote 24 for accessing the delivery storage apparatus 23. There is a cutaway perspective view of a building 100 in FIG. 1. The building may be a dwelling, house, an apartment, etc., including a wall 21, a set of doors 22, and a delivery storage apparatus 23. The delivery storage apparatus 23 is installed in the wall 21.

In alternative exemplary embodiments, the delivery storage apparatus 23 is installed in a front door of a building, fence, gate, window, or another means for dividing or enclosing.

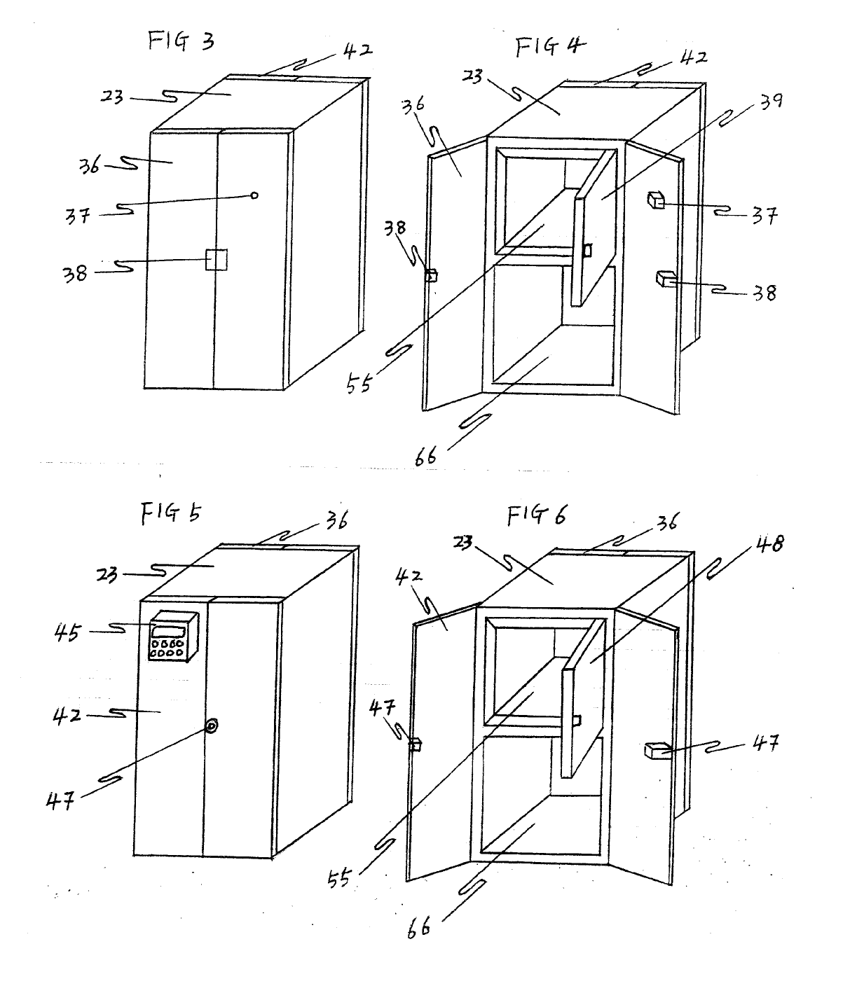

As depicted in FIGS. 2 and 3, the delivery storage apparatus 23 has a first door 36 and a second door 42. The first door 36 and the second door 42 are hingedly connected to the main body of the delivery storage apparatus 23. The first door 36 is accessed from the outside of the building 100 while the second door 47 is accessed from the inside the building 100.

In another exemplary embodiment, the delivery storage device 23 has a rigid door slidably connected to the main body of the delivery storage apparatus 23.

In yet another exemplary embodiment, the delivery storage device 23 has a sliding panel-type door where each of panels are interconnected with hinges and rollers, similar to a garage door.

The delivery storage apparatus 23 is shown in FIGS. 2, 4 and 6 as having two separate compartments. A top compartment 55 with a smaller first inner door 39 and a second inner door 38, is used as a refrigerated or cooled compartment to keep goods cool. A lower compartment 66 is used as a compartment for non-perishable goods that do not need to be stored at a cool temperature. The delivery storage apparatus 23 includes means for cooling 56 known in the art, such as a compressor and dry ice, to maintain the temperature of the top compartment 55 at a low level.

In one exemplary embodiment of the invention, the delivery storage apparatus 23 includes only one of a non-refrigerated storage compartment and a refrigerated storage compartment.

To regulate access to the delivery storage apparatus 23, there is an electronic lock 38 and an electronic sensor 37 that are both disposed on the first door 36 (FIGS. 2, 7, and 8). There is a manual key lock 47 and an electronic control box 45 disposed on the second door 42. The electronic lock 38 and the electronic sensor 37 are connected to the electronic control box 45.

In yet another embodiment of the invention, the electronic sensor 37 is incorporated in the electronic lock 38.

The electronic control box 45 receives or sends information from the electronic lock 38 and the electronic sensor 37 (FIGS. 5 and 7). Through the electronic control box 45, a user can set, adjust or change parameters for accessing the delivery storage apparatus 23 through the first door 36. For example, the user can set a password or a code that unlocks the electronic lock 38.

In an another exemplary embodiment, the delivery storage apparatus 23 includes an electronic lock instead of the manual key lock 47. As described above for the electronic lock 38, access parameters for accessing the delivery storage apparatus 23 through the second door 42 may be set, adjusted or changed for the electronic lock used in lieu of the manual key lock 47 using the electronic control box 45.

An operation of the delivery storage apparatus 23 is described hereinbelow.

A user of the delivery storage apparatus 23 closes the first door 36 and the second door 42. The user also sets the access parameters in the electronic control box 45. For example, the user sets a password in the electronic control box 45 to be used for unlocking the electronic lock 38.

Through an electronic transaction via the Internet, telephone, cellular phone, etc., or through communication via telephone, mail, etc., the user initiates the delivery of goods to the building 100. When the delivery of goods is initiated, the user also sends the password previously set in the electronic control box 45 in the electronic transaction.

In one embodiment, the user places an order for goods through a website of a company on the Internet. In addition to paying for the goods, the user inputs the password through the website.

When the goods to be delivered to the user are transported to the building 100, a deliveryman inputs the user-set password into the remote 24 to access the delivery storage apparatus 23. Specifically, a signal in the form of a radio frequency, infra-red, magnetic field, etc., is transmitted to the electronic sensor 37. The electronic sensor 37 sends the received signal to the electronic control box 45.

Once the electronic control box 45 determines that the received signal matches the preset password, the electronic control box 45 sends a signal to the electronic lock 38. The signal unlocks the electronic lock 38 to allow the deliveryman to open the first door 36. The goods are placed inside the delivery storage apparatus 23 and the first door 36 is then closed.

If perishable goods are being delivered, such goods are placed in the cooled top compartment 55 of the delivery storage apparatus 23.

When the user desires, the user opens the second door 42 using a key to open the manual key lock 47.

Because perishable goods are placed in the refrigerated area, the user does not need to be present in the building to receive the goods or immediately take out the perishable goods out of the delivery storage apparatus 23.

By allowing the delivery service to directly put goods such as groceries into the refrigerated delivery storage apparatus, it allows the user to spend more time on his or her pursuits without having to physically receive the goods from the deliveryman.

The current invention would be useful for individuals who are away from home when goods are delivered, individuals such as working persons living alone, individuals on a business trip or on vacation, etc. Individuals who do not like going shopping would also find this invention useful.

In addition, handicapped individuals, senior citizens, individuals receiving home care, and other mobility-restricted persons would find the invention useful.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-12. (canceled)

13. A method for conducting a transaction over the Internet and delivering goods to a customer, the method comprising:
placing an order for an item at a website by a customer, placing the order comprising inputting a delivery address and a customer-defined password at the website;
delivering the item to the delivery address;
transmitting the customer-defined password to unlock a storage apparatus at the delivery address; and
placing the item in the storage apparatus.

14. The method of claim 13, wherein the item is a food or a foodstuff.

15. The method of claim 13, wherein the item is a perishable food or a perishable foodstuff and the placing the item comprises placing the perishable food or the perishable foodstuff in a cooled compartment of the storage apparatus.
